(19) United States
(12) Patent Application Publication
(10) Pub. No.: US 2017/0152132 A1
(43) Pub. Date: Jun. 1, 2017

(54) REFRIGERATION APPLIANCE HAVING AN ICE AND/OR WATER DISPENSER

(71) Applicant: BSH HAUSGERAETE GMBH, MUNICH (DE)

(72) Inventor: KARL-FRIEDRICH LAIBLE, LANGENAU (DE)

(21) Appl. No.: 15/325,544

(22) PCT Filed: Jul. 24, 2015
(86) PCT No.: PCT/EP2015/066964

§ 371 Date: Jan. 11, 2017

(30) Foreign Application Priority Data
Jul. 25, 2014 (DE) 10 2014 214 630.5

(51) Int. Cl. B67D 1/08; B67D 1/00; F25D 29/00; B67D 1/16; F25D 23/12; F25C 5/00

(52) U.S. Cl. CPC B67D 1/0884; F25D 23/126; F25C 5/005; F25D 29/008; B67D 1/0857; B67D 1/16; B67D 1/0004; B67D 1/0888; F25D 2323/121; F25C 2700/12; F25D 2700/122; F25D 2400/36

(57) ABSTRACT

A refrigeration appliance, in particular a domestic refrigeration device, includes a dispenser for ice and/or water. A communication interface transmits at least one operational status message of the dispenser to an external receiver.

The present invention relates to a refrigeration appliance, in particular a domestic refrigeration appliance, with a dispenser for ice and/or water. Such dispensers are very convenient for users, allowing cold beverages to be enjoyed at any time. However they require a certain degree of attention on the part of the user to be actually ready for use when required and to be able to supply good quality ice or cold water in sufficient quantities.

It is the object of the present invention to create a refrigeration appliance which allows a supply of cold water and/or ice with minimal input on the part of the user.

The object is achieved in that in a refrigeration appliance, in particular a domestic refrigeration appliance, with a dispenser for ice and/or water is equipped with a communication interface for transmitting at least one operational status message from the dispenser to an external receiver.

The external receiver, typically a fixed or mobile computer in the user's home, a smartphone or the like, should be able either to display the received operational status message itself or to forward it, for example by email, SMS in a mobile radio network or in some other suitable manner to a display device, which allows the user to see the operational status message. The user therefore does not have to go to the refrigeration appliance to check the operational status of the dispenser but can check it at the external receiver or where applicable at the display device interacting with the external receiver.

The operational status message can in particular specify an incorrect operational status of the dispenser. This allows the user to conclude that the dispenser is functioning correctly when there is no operational status message. If the user does not receive an operational status message, said user does not have to give attention to the refrigeration appliance and can assume that it is ready for use without restriction.

In one embodiment of the invention the refrigeration appliance can comprise a sensor for detecting the fill level of a reservoir in the dispenser and the operational status message can specify the detected fill level. The operational status message can contain quantitative details of the fill level; alternatively or additionally it can also contain a binary assessment of the fill level as sufficient or insufficient or the operational status message is only transmitted to the external receiver if the fill level is deemed to be unsatisfactory so the user can conclude simply from receipt of the operational status message that remedial action must be taken.

Quantitative details relating to the fill level that may additionally be contained in the message can also provide the user with information about how urgent such remedial action is.

The reservoir can be for example an ice container, typically an ice container that is filled by an ice maker integrated in the dispenser. The remedial action to be taken by the user can then be restricted to switching on the ice maker or selecting an automatic mode, in which a control unit always switches the ice maker on when the level in the ice container drops below a minimum fill level. Such a measure can be undertaken by means of corresponding switches directly on the refrigeration appliance. If the communication interface supports bidirectional communication, as is typically the case with a WLAN interface, the user can also send a corresponding command to the control unit by means of the external receiver.

If the refrigeration appliance is not connected permanently to a building water supply line, the reservoir can also be a water tank.

Convenient dispensers can also feature a CO₂ container and/or a flavoring container in order to carbonate and/or flavor the dispensed water. The operational status message can then also specify the fill level of such a container, in order to indicate to the user when the container is largely empty and should be replaced or refilled.

A sensor for detecting the capacity of a residue storage unit can also be provided and the operational status message can specify the detected capacity of the storage unit.

One example of such a residue storage unit can be a filter, which is arranged in a supply line to the dispenser to remove unwanted matter in the water as well as substances use to sterilize the water, carriers of unwanted odors or contaminants. Such filters have to be replaced or regenerated from time to time to maintain their effectiveness.

A further example of a residue storage unit can be a drip tray, as arranged conventionally below an outlet of the dispenser, which has to be emptied from time to time, in particular if the dispenser is used intensively, to prevent it overflowing.

Some types of ice maker do not use molds, in which the water freezes completely. Instead they use cooling fingers which are immersed in a water trough, the water freezing on their surfaces. This causes dissolved salts to accumulate in the still liquid part of the water, producing brine residues which should not be frozen as they would spoil the taste of the ice so have to be conducted away into a collector. If it is not connected to a waste water line, this collector must also be emptied from time to time, it being possible for the user to be alerted thereto by a suitable operational status message.

The invention can also be used to improve the operational safety of the refrigeration appliance. A sensor for detecting water throughput and a shut-off valve can be provided in a supply line to the dispenser and the operational status message can be generated if a non-diminishing throughput through the supply line is detected when the shut-off valve is closed, indicating that there is a leak in the dispenser.

To protect against internal leaks and the like of a normally pressurized hose for connection to a domestic water supply line, water-consuming domestic appliances such as dishwashers and washing machines are conventionally equipped with a safety valve which is arranged at an inlet of the hose and controlled by a leak detector. According to the invention the refrigeration appliance can also be equipped with such a safety valve and the operational status message can indicate blocking of the safety valve to alert the user to the presence of a fault where applicable. The user can then contact a customer service department immediately to initiate the elimination of the fault. It is also conceivable in such an instance for the operational status message to be transmitted automatically to the customer service department without the need for intervention on the part of the user in order to allow it to diagnose the cause of the fault remotely, where applicable based on further details contained in the operational status message.

A temperature sensor can also be provided in an ice production or storage region of the dispenser and the operational status message can specify the temperature detected by the sensor. Too high a temperature in said region can indicate that a door of the refrigeration appliance has inadvertently been left open or that a cold air channel between the ice production or storage region and an evaporator is blocked, in other words faults that can normally be easily rectified by the user and do not require customer service department input.

If the refrigeration appliance can be switched between a normal cooling operational status and a cooling operational status with preferred dispenser cooling, the operational status message can specify which of said operational statuses is currently active.

A switch between normal cooling operational status and the cooling operational status with preferred dispenser cooling can expediently also take place by means of a command received by way of the communication interface.

A display screen for displaying the operational status message should also be provided on the refrigeration appliance itself. Such a display screen can also be designed to display information received by way of the communication interface. This information does not have to be restricted to the operation of the refrigeration appliance itself; in principle any information, in particular also internet content, can be displayed.

Further features and advantages of the invention will emerge from the description of exemplary embodiments which follows with reference to the accompanying FIGURE.

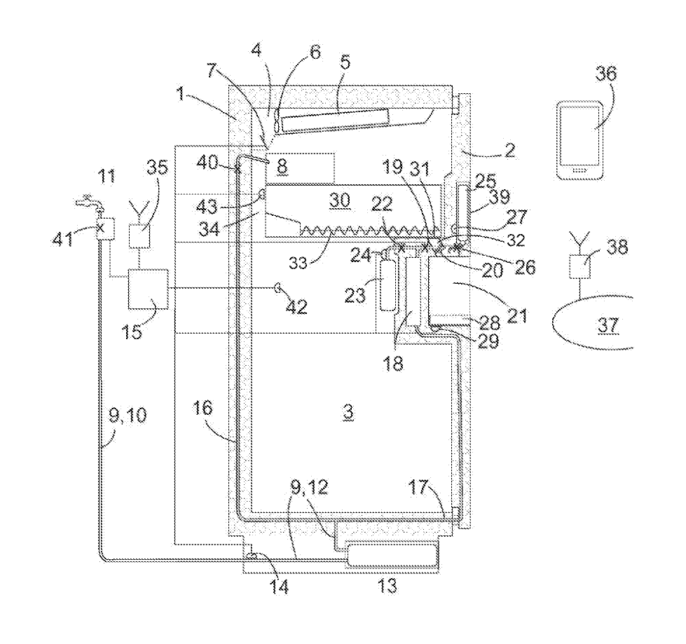

FIG. 1 shows a schematic diagram of an inventive domestic refrigeration appliance and receivers interacting with it.

The refrigeration appliance shown in FIG. 1 has a heat-insulating body 1 shown in cross section in the FIGURE and a door 2, which together delimit a cooled storage compartment, in this instance a freezer compartment 3. Divided off from the freezer compartment 3 in an upper part of the body 1 is an evaporator chamber 4, which contains an evaporator 5, a fan 6 for driving the exchange of air between the evaporator chamber 4 and the freezer compartment 3 as well as a flap 7 for controlling the path of the air flow driven by the fan 6.

An automatic ice maker 8 is arranged in the freezer compartment directly below the evaporator chamber 4. The structure of the automatic ice maker 8 is not shown in the FIGURE as such ice makers are known and the applicability of the invention is not restricted to a specific type of ice maker. In particular ice maker 8 can have a tray with a number of ice cube molds to be filled with water in the known manner or an arrangement of cooling fingers that engage in the tray can be provided, the water in the tray freezing on their surfaces.

A line 9 is provided to supply the ice maker 8 with fresh water. An upstream segment of the line 9 is formed by a flexible hose 10, which is provided to be connected to a faucet 11 of a domestic water supply line, as shown. A line segment 12 permanently incorporated in the body 1 connects to the hose 10, with a replaceable filter cartridge 13 inserted therein. A throughflow sensor 14 is arranged on the line segment 12 and connected to an electronic control unit 15, which estimates the residual capacity of the filter cartridge 13, in particular the quantity of water that can still flow through the filter cartridge 13 before the filter capacity is exhausted or the probable remaining residual operating time of the filter cartridge 13 until such quantity has flowed through, based on the water consumption detected by the sensor 14.

Downstream of the filter cartridge 13 the line 9 forks into one branch 16 leading to the ice maker by way of a solenoid valve 40 and one branch 17 that passes through a hinge into the door 2 to supply a water tank 18.

The water tank 18 is embedded in a heat-insulating layer of the door 2 in such a manner that the temperature in it is just above 0° C. when the refrigeration appliance is operating at normal ambient temperature. The tank 18 is connected by way of a solenoid valve 19 controlled by the control unit 15 to a water outlet 20 at the top of a dispenser recess 21 formed in the door 2.

In the embodiment shown here the water tank 20 can be supplied with carbon dioxide from a replaceable pressurized cylinder 23 by way of a further solenoid valve 22 controlled by the control unit 15. A pressure sensor 24 arranged on a line segment between the pressurized cylinder 23 and the solenoid valve 22 allows the control unit 22 to estimate the residual content of the pressurized cylinder 23 based on the pressure measured in the line segment.

A storage bottle 25 for a soda base or another flavoring suitable for mixing with water output at the water outlet 20 is fitted in a replaceable manner in the door 2 and connected by way of a solenoid valve 26 to an outlet adjacent to the water outlet 20 at the top of the dispenser recess 21. A fill level sensor 27 for detecting the contents of the storage bottle 25 is connected to the control unit 15.

A drip tray 28 is arranged in a removable manner at the base of the dispenser recess 21. It is also associated with a fill level sensor 29 connected to the control unit 15.

Arranged below the ice maker 8 is an ice storage container 30, into which finished ice cubes are ejected from the ice maker 8. An output opening 31 at the front end of the storage container 30 communicates with an ice passage 32 at the top of the dispenser recess 21. A motorized spiral conveyor 33 at the base of the storage container 30 is provided to move the ice cubes in the storage container 30 from time to time to prevent them freezing together and to convey them to the output opening 31 as required.

A passage 34 is kept free between the rear faces of the ice maker 8 and the storage container 30 on the one hand and a rear wall of the body 1 on the other hand, it being possible for cold air from the evaporator chamber 4 to pass through this into a region of the freezer compartment 3 below the storage container 30 when the flap 7 is correspondingly positioned.

The control unit 15 is connected to a WLAN radio interface 35, which allows bidirectional communication with other WLAN users, such as a smartphone 36, a tablet computer, a PC or a WLAN repeater 38 connected to the telephone network 37.

The control unit 15 uses the values measured by the throughflow sensor 14 to estimate the residual capacity of the filter cartridge 13 and sends a message by way of the radio interface 35 when said residual capacity drops below a predefined limit value or a limit value programmed by the user. The user is able to set at the control unit 15 whether the message is only to be transmitted within the WLAN, for example to the smartphone 36, to inform said user of the need to change the cartridge, or whether such a message should go directly to the address of a merchant input by the user, for example in the form of an email, by way of the repeater 38 and the telephone network 37, so that said merchant supplies a replacement cartridge.

A user interface, at which such settings can be input for the control unit 15, can comprise a display screen 39, in this instance on the door 2 of the refrigeration appliance. If the control unit 15 is configured to send operational status reports in the form of emails by way of the telephone network 37, it can also be used to receive any internet content relating to the telephone network 37 and the repeater 38 in the counter direction and display it on the display screen 39.

If the control unit 15 has been configured to communicate with a mobile device, such as the smartphone 36, a user interface, which can be used to undertake further configurations of the control unit 15 or to change existing configurations, can also be implemented in the form of an application program on the mobile terminal.

In the same way as it monitors the residual capacity of the filter cartridge 13, the control unit 15 also uses the pressure sensor 24 to monitor the fill level of the pressurized cylinder 23 and generates an operational status message as soon as the pressure drops below a limit value, indicating the need to replace or refill the pressurized cylinder 23 in the near future. Depending on the user's preference this message can also be transmitted within the WLAN and/or can be sent as an email to a predefined address. If the predefined email address belongs to a terminal associated with the user, said user can also be informed of the need to obtain a replacement even if said user is not in range of the WLAN. However the email can also be sent directly to a merchant or service provider to ensure the replacement.

A message indicating the need to obtain a replacement is generated correspondingly when the fill level sensor 27 detects a low fill level in the storage bottle 25.

In particular if the sensors 14, 24, 27 allow a quantitative detection of the residual capacity of the filter cartridge 13 or the residual content of the pressurized cylinder 23 or the storage bottle 25, it can also be expedient for the control unit 15 to respond to receipt of a corresponding request by way of the radio interface 35 by supplying an operational status message relating to the residual capacity or fill level so that, if the user has the opportunity of obtaining a replacement at a corresponding sales point, said user can be made aware of the urgency of obtaining a replacement by a remote request, without having to go to the appliance.

The fill level sensor 29 monitors the contents of the drip tray 28. When the solenoid valve 19 operates correctly, the fill level of the drip tray 28 should increase slightly shortly after water has been drawn off from the tank 18. It is then generally sufficient for the control unit 15 to send an operational status message within the WLAN to alert the user to the need to empty the drip tray 28 when said user is in range of the WLAN in proximity to the refrigeration appliance.

In contrast if the water level in the drip tray 28 rises continuously, without the solenoid valve 19 being activated, the control unit 15 identifies that there is a leak. The control unit 15 then blocks a safety valve 41 at the inlet end of the hose 10, to prevent the drip tray 20 overflowing and sends a corresponding fault message beyond the limits of the WLAN. The fault message can be can be produced by the control unit 15 in the form of an email that only has to be forwarded by the repeater 38; it can also be a message within the WLAN, prompting another WLAN user, e.g. a PC, to send a corresponding email.

The control unit 15 responds in the same manner by blocking the safety valve 41 and sending a fault message if a non-diminishing throughflow at the sensor 14 when the solenoid valves 19, 40 are closed indicates a leak in the water-conducting system downstream of the throughflow sensor 14 or if a sensor in a shield (not shown in FIG. 1) enclosing the hose 10 detects fluid water which indicates a leak in the hose 10.

The control unit 15 can control the operation of a compressor (not shown in FIG. 1) in a manner known per se based on the temperature in the freezer compartment 3 as detected by a temperature sensor 42. If the freezer compartment 3 heats up to above a predefined setpoint temperature, even though the control unit 15 has activated the compressor, this indicates a fault such as the door 2 not being properly closed or a defect in the compressor and the control unit 15 generates an operational status message giving notice of too high a temperature to prompt the user to take remedial action.

As mentioned above, the smartphone 36 or another computer, which may be connected to the radio interface 35 within the WLAN or to the WLAN by way of the telephone network 37 and the WLAN repeater 38, can be used to request sensor data from the control unit 15 or to check the correct functioning of the refrigeration appliance in some other manner. Commands relating to the operation of the refrigeration appliance can equally be transmitted directly in the counter direction in this manner to be executed by the control unit 15. The option can therefore be provided for example for the ice maker 8 to be switched on by means of a command transmitted by way of the WLAN interface 35. In the simplest instance switching on here can consist of opening the solenoid valve 40 once to fill a tray in the ice maker with water and allowing the water to freeze. Alternatively or additionally the option can be provided for activating an automatic operating mode of the ice maker, which consists of repeatedly filling the tray with water and ejecting the finished ice cubes therefrom until a fill level sensor 43 on the ice storage container 30 indicates that the ice storage container is full. The user is thus able to start ice production if an unforeseen need arises, without having to go to the refrigeration appliance.

To speed up ice production commands can also be transmitted to the control unit 15 by way of the WLAN radio interface 35 to influence the setpoint temperature in the freezer compartment 3 and/or the position of the flap 7. It is thus possible to activate a rapid cooling mode, in which the setpoint temperature of the freezer compartment 3 is much lower than in normal cooling mode and which typically results in the compressor running continuously for the duration of rapid cooling mode. Both the uninterrupted supply of cold air to the ice maker 8 and the temperature drop in the freezer compartment 3 speed up ice formation,

The control unit 15 can also be prompted by means of a command transmitted by way of the WLAN radio interface 35 to position the flap 7 in such a manner that it blocks the passage 34 completely or to a large degree so that all or at least the majority of the cold air circulated by the fan 6 flows through the ice maker 8 and thus causes the water in the tray to freeze very quickly.

The control unit 15 confirms the execution of the commands by means of corresponding operational status messages informing the user that the appliance is operating according to instructions.

### REFERENCE CHARACTERS

1 Body
2 Door
3 Freezer compartment
4 Evaporator chamber
5 Evaporator
6 Fan
7 Flap
8 Ice maker
9 Line
10 Hose
11 Faucet
12 Line segment
13 Filter cartridge
14 Throughflow sensor
15 Control unit
16 Branch
17 Branch
18 Water tank
19 Solenoid valve
20 Water outlet
21 Dispenser recess
22 Solenoid valve
23 Pressurized cylinder
24 Pressure sensor
25 Storage bottle
26 Solenoid valve
27 Fill level sensor
28 Drip tray
29 Fill level sensor
30 Ice storage container
31 Output opening
32 Ice passage
33 Spiral conveyor
34 Passage
35 WLAN radio interface
36 Smartphone
37 Telephone network
38 WLAN repeater
39 Display screen
40 Solenoid valve
41 Safety valve
42 Temperature sensor
43 Fill level sensor

1-14. (canceled)

15. A refrigeration appliance or domestic refrigeration appliance, comprising:
a dispenser for at least one of ice or water; and
a communication interface for transmitting at least one operational status message from said dispenser to an external receiver.

16. The refrigeration appliance according to claim 15, wherein said at least one operational status message specifies an incorrect operational status of said dispenser.

17. The refrigeration appliance according to claim 15, which further comprises:
a reservoir disposed in said dispenser; and
a sensor for detecting a fill level of said reservoir;
said at least one operational status message specifying said fill level detected by said sensor.

18. The refrigeration appliance according to claim 17, wherein said reservoir is an ice container, a water tank, a CO₂ container or a flavoring container.

19. The refrigeration appliance according to claim 15, which further comprises:
a residue storage unit having a capacity; and
a sensor for detecting said capacity of said residue storage unit;
said at least one operational status message specifying said capacity detected by said sensor.

20. The refrigeration appliance according to claim 19, which further comprises a supply line leading to said dispenser, said residue storage unit being a filter disposed in said supply line, a drip tray or a brine collector.

21. The refrigeration appliance according to claim 15, which further comprises:
a supply line leading to said dispenser and having a water throughput;
a sensor for detecting said water throughput; and
a shut-off valve in said supply line;
said at least one operational status message signaling a non-diminishing throughput through said supply line when said shut-off valve is closed.

22. The refrigeration appliance according to claim 15, which further comprises:
a refrigeration appliance housing;
a supply line leading to said dispenser, said supply line including a hose running outside said housing and having an inlet; and
a safety valve disposed at said inlet of said hose;
said at least one operational status message indicating blockage of said safety valve.

23. The refrigeration appliance according to claim 15, wherein:
said dispenser includes an ice production or storage region;
a temperature sensor is provided in said ice production or storage region of said dispenser; and
said at least one operational status message specifies a temperature detected by said temperature sensor.

24. The refrigeration appliance according to claim 15, wherein the refrigeration appliance can be switched between a normal cooling operational status and a cooling operational status with preferred dispenser cooling, and said at least one operational status message specifies which of said cooling operational statuses is active.

25. The refrigeration appliance according to claim 25, which further comprises a water tank or ice maker disposed in said dispenser, said normal cooling operational status and said cooling operational status with preferred dispenser cooling relating to cooling of said water tank or ice maker.

26. The refrigeration appliance according to claim 15, wherein the refrigeration appliance can be switched between a normal cooling operational status and a cooling operational status with preferred dispenser cooling by a command received by way of said communication interface.

27. The refrigeration appliance according to claim 26, which further comprises a water tank or ice maker disposed in said dispenser, said normal cooling operational status and said cooling operational status with preferred dispenser cooling relating to cooling of said water tank or ice maker.

28. The refrigeration appliance according to claim 15, which further comprises a display screen for displaying said at least one operational status message.

29. The refrigeration appliance according to claim 28, wherein said display screen also displays information received by way of said communication interface.

30. The refrigeration appliance according to claim 15, wherein said communication interface is a WLAN interface.
